(19) United States
(12) Patent Application Publication
(10) Pub. No.: US 2026/0288191 A1
(43) Pub. Date: Sep. 24, 2026

(54) RECEPTACLE PART, A CONTROL ASSEMBLY, A HOUSEHOLD APPLIANCE, AND A METHOD FOR MOUNTING

(71) Applicants: BSH Home Appliances Corporation, Irvine, CA (US); BSH Hausgeräte GmbH, Munich (DE)

(72) Inventors: Eduardo Borbolla Jimenez, Boo de Piélagos (Cantabria) (ES); Cesar Aguado Vela, Camargo (ES); Carlos Pelayo Alonso, Villafufre (Cantabria) (ES); Roberto Carballo Fernandez, Santander (Cantabria) (ES)

(21) Appl. No.: 19/083,500

(22) Filed: Mar. 19, 2025

(51) Int. Cl. G05G 1/10; F24C 3/12

(52) U.S. Cl. CPC G05G 1/10; F24C 3/122; F24C 3/124

(57) ABSTRACT

A receptacle part is disclosed for a rotatable knob of a household appliance having a control panel including at least one aperture through which a shaft may be coupled with the rotatable knob along a rotational axis. The receptacle part may include: a sleeve portion for partially enclosing the rotatable knob; and a coupling portion for removably mounting the receptacle part to the control panel, wherein the coupling portion comprises a central opening, and at least one holding element implemented to establish a form-fit coupling by rotational interlocking with a corresponding coupling section of the control panel.

### FIELD

The present disclosure relates to a receptacle part for a rotatable knob of a household appliance. Further, the present disclosure relates to a control assembly, a household appliance, and a method for mounting a knob.

### INTRODUCTION

Conventional gas stoves comprise a cooking hob on a top side and control mechanisms, such as control knobs, arranged on a control panel on a front side. The cooking hob may include burners that combust gas to generate heat for cooking. A gas flow, implemented to supply gas to the burner, is regulated by the control knob. The control knob is thus coupled to one end of a shaft through an opening in the control panel. This shaft may be connected to a gas valve. By turning the control knob, the shaft is rotated, adjusting the gas valve to either increase or decrease the gas flow and consequently, the cooking heat.

During use, gas stoves may become dirty. For instance, food and liquids may spill onto both the top side and the front side. These spills, especially liquids, may enter through the opening for coupling the shaft to the inside of the gas stove, potentially damaging internal components, in particular, electrical components.

To prevent spills from entering the stove's interior, a receptacle may enclose the opening and partially cover the control knob. Known receptacles are fastened to the control panel with screws, which may complicate the assembly process.

### SUMMARY

It is one object of the present disclosure to provide an improved receptacle part.

According to a first aspect, a receptacle part for a rotatable knob of a household appliance is provided. The household appliance comprises a control panel, the control panel comprising at least one aperture through which a rotational axis extends, wherein a shaft may be coupled with the rotatable knob, e.g. along the rotational axis. The receptacle part comprises: a sleeve portion for partially enclosing the rotatable knob and a coupling portion for removably mounting the receptacle part to the control panel. The coupling portion comprises a central opening, and at least one holding element implemented to establish a form-fit coupling by rotational interlocking with a corresponding coupling section of the control panel.

Advantageously, using a form-fit for mounting the receptacle part to the corresponding coupling section is, during assembly, less time-consuming compared to using additional fixing means, such as screws. Therefore, the mounting process of the receptacle part may be reduced, saving on time and therefore cost.

The household appliance is, for example, a stove, in particular, a gas stove, a cooktop, an oven, or a microwave oven.

The control panel may be positioned on a front side or a top side of the household appliance. The control panel may be implemented to provide control instruments for the household appliance. The rotatable control knob may be one of the control instruments. The control panel may comprise a multitude of control instruments, for example, control knobs, a display, a switch, or a button.

Further, the control panel comprises at least one aperture. Furthermore, the control panel comprises one aperture per control instrument. The at least one aperture may be implemented in the control panel to provide a connection for the control instruments to inner components of the household appliance. In case of being a gas stove, “inner components” may, for example, be the shaft, and a gas valve, wherein the shaft may be connected to the gas valve. The shaft may be rotatable, wherein a rotation of the shaft may open or close the gas valve. The shaft may be rotatable along the rotational axis. The rotational axis may correspond to a middle axis of the shaft. The rotational axis may extend through the aperture of the control panel.

In particular, the shaft, more specifically, an end of the shaft, extends through the aperture. In particular, the control instrument, for example, a coupling section of the control instrument extends through the aperture. The control instrument and the shaft may be coupled in a torque-proof manner. Therefore, the control instrument, for example, the rotatable knob, may be rotated, thus transferring the torque around the rotational axis onto the shaft.

The rotational axis may define spatial directions, such as an axial direction extending along or parallel to the rotational axis and a radial direction extending perpendicular to the rotational axis. Wordings such as “parallel” and “perpendicular” may include deviations due to a manufacturing process or an assembling process. For example, the deviations may be up to 5%. In another example, the deviations may be up to 10%.

The sleeve portion may protrude in the axial direction. In particular, the sleeve portion may have a cylindrical shape, with a ring-like cross-section. In other examples, the sleeve portion may have a frame-like cross-section. The sleeve portion may be implemented to, at least partially, accommodate the rotatable knob. Thus, the sleeve portion may comprise a cavity, wherein within the cavity, the rotatable knob may be placed. The sleeve portion may accommodate the rotatable knob circumferentially.

The coupling portion may be arranged on one end of the sleeve portion in the axial direction. The receptacle part may, in particular, be removably mounted at or adjacent to the aperture of the control panel. “Removably” means in this context, that the coupling portion may enable a non-destructive detachment of the receptacle part from the control panel.

The central opening may have a circular shape. In embodiments, the central opening may have the shape of a polygon. The rotational axis may extend through the central opening. The rotational axis may pass through a center point of the central opening. An end of the shaft may extend through the central opening. For example, the control knob may, at least partly, extend through the central opening. The central opening and the aperture may be arranged in a coinciding way.

An apron may be arranged circumferentially around the central opening. The apron may protrude in the axial direction.

The holding element may, in particular, protrude in the axial direction from the coupling portion. In particular, the coupling section comprises a flat surface, wherein the holding element protrudes from the flat surface.

“Form-fit coupling”, also known as form-fit connection, is a mechanical connection that relies on the geometric shapes of components to interlock and secure them together, effectively preventing separation or unwanted movement.

The rotation may, in particular, be performed by turning the receptacle part along the rotational axis. For example, the rotation may be performed by rotating the receptacle part along a central axis of the coupling portion.

“Interlocking” refers to the action of fitting together securely, where components are designed to connect in such a way that their movements or operations are constrained by one another. This mechanism ensures that the parts cannot operate independently, creating a stable and cohesive structure or system.

The mechanism described for coupling the receptacle part, for example, to the control panel may be a bayonet mount in embodiments.

According to an embodiment, the holding element comprises: a first segment protruding in an axial direction from the coupling portion; and a second segment having an unsupported end and extending in a circumferential direction.

Advantageously, the shape of the holding element is simple, allowing the manufacturing of the receptacle part with the so-shaped holding element in one manufacturing step.

One end of the first segment may be coupled to the coupling section. The coupling section and the first segment may be made in a one-piece manner. The first segment may be implemented to bear the second segment, and therefore, restrict all the degrees of freedom of the second segment.

In a three-dimensional space, there are six degrees of freedom, which define the position and orientation of a rigid body. These consist of three translational degrees of freedom (movement along the X, Y, and Z axes) and three rotational degrees of freedom (rotation around the X, Y, and Z axes, also known as pitch, yaw, and roll).

The second segment may span over a segment circumferentially around the central opening. The segment may sweep an angle between 70 degrees and 90 degrees. In particular, the second segment extends parallel to the previously mentioned flat surface of the coupling portion.

The second segment may have a thickness and a length with a ratio between 1:15 to 1:45, preferably between 1:20 and 1:40, even more preferably between 1:25 and 1:35, e.g. of 1:29. In particular, the second segment may be ductile, in order to withstand elongations. The second segment and the first segment may be shaped in a one-piece manner.

The second segment may be configured to create an undercut by being solely supported by the first segment, wherein the second segment comprises a supported end implemented to connect the first segment and the second segment. The supported end is, in particular, arranged opposite of the unsupported end.

The undercut may be arranged between the second segment and a flat surface of the receptacle part. The undercut may have the shape of a slit, wherein the slit is arranged between the second segment and the flat surface. The slit may have a height between 0.5 mm and 1.5 mm, preferably between 0.7 mm and 1.3 mm, and even more preferred between 0.8 mm and 1.1 mm. In particular, the slit may be implemented to receive at least a part of a sheet metal. Thus, the height of the slit may be higher than the thickness of the sheet metal.

In particular, geometrical measures, such as height, widths, lengths and/or thicknesses may underly deviations due to manufacturing reasons. The deviations may include differences of up to 5%, or up to 10%.

According to an embodiment, the second segment further comprises a third segment located at the unsupported end, wherein the third segment extends towards the coupling portion in the axial direction.

Advantageously, in a state in which a form-fit coupling is established, the third segment may prevent the form-fit coupling from unintentionally loosening.

The third segment may, in particular, have the shape of a wedge.

The third segment may extend over the height of the undercut. For example, the coupling portion comprises at least one opening extending circumferentially underneath the second segment, wherein the third segment protrudes axially at least partly into the opening.

In the state in which the form-fit coupling is established, the third segment may engage in a corresponding opening, wherein the corresponding opening is arranged at the corresponding coupling section of a counterpart, for example, the control panel. Therefore, the third segment may be implemented to prevent the rotational movement of the receptacle part, when a form-fit coupling is established. For removing the receptacle part from the state, in which a form-fit coupling is established, the third segment may be pushed out of the corresponding opening.

According to an embodiment, the holding element is arranged around the central opening.

Advantageously, by arranging the holding element around the central opening, a sealing effect may be enhanced.

According to an embodiment, the holding element is implemented to exercise an axially directed holding force in a form-fit coupled state.

Advantageously, the holding force may prevent unintentional loosening of the form-fit coupling.

The holding force may have at least a share in the axial direction. The holding force may be created by the second segment acting on a back side of the control panel, therefore the holding force prevents the receptacle part from loosening in the axial direction.

In particular, the third segment is implemented to lock, e.g. by latching with the corresponding opening of the coupling section, a movement of the receptacle part in the circumferential direction.

The holding force may be exercised by the holding element on a back side of the control panel. The holding force may prevent the receptacle part from loosening in the axial direction. The holding force is, for example, generated as a response to the receptacle becoming loose in the axial direction.

According to an embodiment, the receptacle part has a cylindrical shape.

The outer shell of the receptacle part may have the shape of a circular cylinder or a polygonal cylinder.

According to an embodiment, the receptacle part is at least partially made from a zinc-based alloy.

The zinc-based alloy offers corrosion resistance and strength, making the receptacle part durable and long-lasting.

The receptacle part may be manufactured from Zamak. “Zamak” is a family of zinc-based alloys which comprise aluminum, magnesium, and copper. For example, the receptacle part may be made from Zamak 3, which may also be referred to as ZL0400 or ZnAl4. When using Zamak 3, the receptacle part may be made by die casting.

The receptacle part may be additionally or alternatively made from plastic, stainless steel, or cast iron. In the case the receptacle part is made from plastic, the plastic may be Polybutylene terephthalate (PBT) or polycarbonate/acrylonitrile-butadiene-styrene (PC+ABS).

According to an embodiment, the coupling portion comprises a maximum of two holding elements.

Advantageously, strain resulting from external forces acting on the receptacle part are distributed between the two holding elements, making the coupling more durable.

The two holding elements may be arranged with an offset of 180 degrees circumferentially around the central opening. The unsupported ends of the two holding elements may be arranged in the same direction, either clockwise or counter-clockwise.

According to a second aspect, a control panel for a household appliance is provided. The control panel comprises an aperture through which a rotational axis extends. The aperture comprises at least one coupling section implemented to establish a form-fit coupling by rotational interlocking with a corresponding coupling section of the receptacle part, e.g. according to the first aspect and/or one of the above-described embodiments, and arranged circumferentially around the aperture.

Advantageously, the circumferentially arranged form-fit coupling around the aperture ensures a correct placement of the receptacle part relative to the control panel.

The control panel may be arranged at a front side of the household appliance and is, e.g. vertically or horizontally arranged. Therefore, the control panel may cover, at least partly, inner components and/or instruments of the household appliance. The control panel may be implemented to display a state of the household appliance, such as a temperature, a time, and/or a scale.

The aperture may be a through hole, extending from a front side of the control panel to a back side of the control panel. The aperture may have a circular cross-section. In another embodiment, the cross-section of the aperture may be polygon-shaped.

The coupling section may be a part of the aperture. The coupling section may be shaped as a through hole, connecting the front side of the control panel to the back side of the control panel. The coupling section comprises, for example, corresponding openings and/or protrusions for receiving the coupling section of the receptacle part.

The control panel may be made from plastic, which may be injection-molded. The aperture may therefore be made while manufacturing the control panel, by providing an appropriate mold. The coupling section may also be manufactured by providing an appropriate mold.

The control panel may, in another example, be made from sheet metal, wherein the aperture may be punched out. The coupling section may be punched out in cases of the control panel being made from sheet metal.

According to an embodiment, the at least one coupling section comprises: at least one opening extending in a radial and circumferential direction, implemented to receive a holding element; and at least one holding section arranged adjacent to the at least one opening and extending circumferentially around the at least one opening.

Establishing the form-fit coupling between the receptacle part and the control panel by openings of the material of the control panel has the advantage of being cheap and easy to manufacture. Especially, in cases, where the control panel is of low thickness.

The holding element may be inserted into the opening from the axial direction. Therefore, the opening may, in particular, have wide enough dimensions in the axial direction and in the circumferential direction for receiving the holding element.

The holding section may be made in a one-piece manner from the material of the control panel. The holding section may protrude in the radial direction towards a center point of the aperture. The holding section may extend in the circumferential direction having the length of the second segment.

The holding section may extend in the circumferential direction with the length of the second segment without the unsupported end of the second segment.

According to an embodiment, the aperture and the at least one opening are radially separated openings.

Separating the aperture and the opening may stiffen the construction of the control panel.

The opening may be separated from the aperture by a link between the opening and the aperture. The link may, in particular, be designed in a one-piece manner with the control panel.

According to an embodiment, the control panel comprises a maximum of two coupling sections.

Advantageously, the receptacle part and the control panel may be coupled in a more reliable way compared to a coupling by one coupling section.

The two coupling sections may be arranged circumferentially around the aperture with an offset of 180 degrees.

According to a third aspect, a household appliance is provided. The household appliance comprises: a receptacle part according to an embodiment of the first aspect; and a control panel according to an embodiment of the second aspect, wherein the receptacle part and the control panel are coupled to one another in a form-fit manner, and have a contact surface at an outer side of the control panel.

For example, the receptacle part and the control panel may have a contact surface, wherein the contact surface is arranged circumferentially around the aperture. The contact surface may be positioned on the front side of the control panel.

According to embodiments, a holding element of the receptacle part exercises a holding force onto a back side of the control panel in a form-fit coupled state.

Advantageously, by applying the holding force to the back side of the control panel, a secure fit between the receptacle part and the control panel is achieved.

The holding force may, in particular, be generated by a spring-like effect of the holding element. Therefore, the holding element may have a certain ductility.

The holding force may be directed in the axial direction towards the front side of the control panel.

According to a fourth aspect a method for mounting is provided a receptacle part according to the first aspect to a control panel according to the second aspect of a control assembly is provided. The method comprises: inserting a holding element of the receptacle part into an opening of the control panel, wherein the receptacle part and the control panel form a contact surface; and rotating the receptacle part around a rotational axis in a locking direction.

The presented method relies on the form-fit coupling of the receptacle part to the control panel. Therefore, further coupling means, such as screws, may be neglected. The method allows for easy assembly, saving on complexity and cost. Additionally, the receptacle part and the control panel have sufficient alignment. Also disassembling and changing the part is facilitated by the method.

The receptacle part is, in particular, rotated about an angle between 70 degrees and 90 degrees. The receptacle part is, in particular, rotated clockwise in circumferential direction.

In particular, a clicking sound may be heard, wherein the clicking sound may indicate the successfully established form-fit coupling.

The embodiments and features described with reference to the first aspect or according to an embodiment thereof apply mutatis mutandis to the second, third and fourth aspects.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

Further embodiments, features, and advantages of the present disclosure will become apparent from the subsequent description and dependent claims, taken in conjunction with the accompanying drawings, in which:

FIG. 1 shows a perspective view of a section of an embodiment of a gas stove;

FIG. 2 shows a perspective view of a back side of an embodiment of a receptacle part;

FIG. 3 shows a side view of an embodiment of a receptacle part coupled with a control panel;

FIG. 4. shows an embodiment of a section of a receptacle part;

FIGS. 5A-5C show a simulation result;

FIGS. 6A-6C show an example of a coupling process;

FIG. 7 shows steps of a method for mounting; and

FIG. 8 is a schematic sectional exploded view of an illustrative receptacle part, knob, and control panel.

In the Figures, like reference numerals designate like or functionally equivalent elements, unless otherwise indicated.

### DETAILED DESCRIPTION

Various aspects and examples of a receptacle part, as well as related methods, are described below and illustrated in the associated drawings. Unless otherwise specified, a receptacle part in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

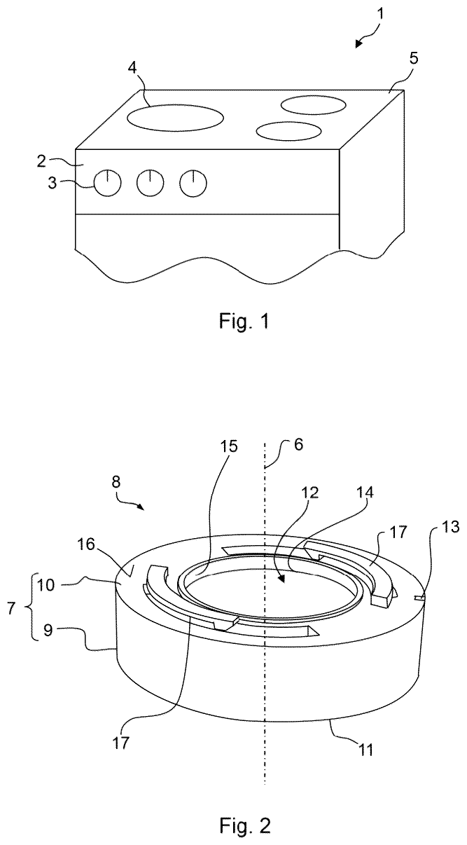

FIG. 1 shows a section of a household appliance, in particular, a gas stove 1. The gas stove 1 comprises a control panel 2 and knobs 3 comprised of control knob arrangements, wherein the control panel 2 may be oriented to a front side of the gas stove 1. The gas stove 1 further comprises burners 4. The burners 4 may each have different sizes, wherein the burners 4 are located on a top plate 5, arranged on a top side of the gas stove 1.

The knobs 3 are implemented to control a gas supply for the burners 4, which is not shown in FIG. 1. Therefore, the knob 3 may be rotated relative to a rotational axis 6 (see FIG. 2). Rotating the knob 3 may, depending on the rotational angle, set the gas supplied to the burners 4. Depending on the supplied gas, heat, for example, for cooking, is generated by the burners, corresponding to a rotation angle of the knob 3.

The gas stove 1 of FIG. 1 may further comprise at least one receptacle part 7 (see FIG. 2) as part of the control knob arrangement, for receiving the knob 3. The receptacle part 7 is arranged circumferentially around the knob 3. The knob 3 covers an aperture (not shown in FIG. 1) in the control panel 2 at the front side of the gas stove 1, wherein the receptacle part 7 is also arranged around said aperture.

FIG. 2 shows a perspective view of an embodiment of a bottom side 8 of the receptacle part 7. The receptacle part 7 has a cylindrical shape comprising a ring-like cross section in a radial direction. The receptacle part 7 comprises a first section 9 and a second section 10 extending along the rotational axis 6 and being connected in a one-piece manner.

The first section 9 comprises a sleeve-like portion. The sleeve-like portion has an opening (not shown in FIG. 2) at a first end 11, established to receive the knob 3. The respective knob can be partially enclosed by the sleeve-like portion 9. E.g. the knob can be rotated within the receptacle part 7.

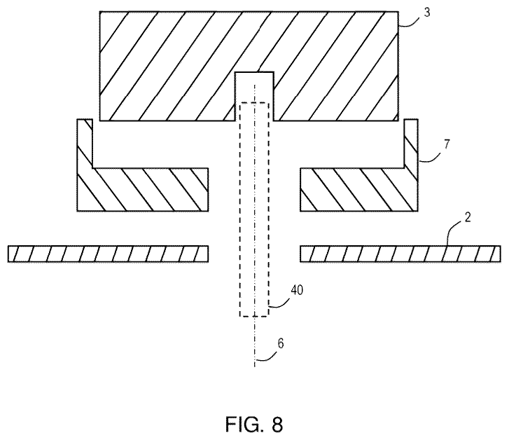

The first end 11 may be equal to a front side of the receptacle part 7. The first section 9 has a ring-like cross-section across the axis 6. Further, the first section 9 comprises a central opening 12 extending from the first end 11 along the rotational axis 6 to the second section 10, wherein the first section 9 and the second section 10 merge at one edge. Within the central opening 12, coupling means may reach through the opening 12 for coupling the knob 3 to further control instruments, e.g., a valve shaft (40), which is not shown in FIG. 2 (see FIG. 8). The first section 9 encloses the knob 3 circumferentially, therefore shielding the knob 3 from damages. The first section 9 further comprises an indicator 13. The indicator 13 may be arranged as a slit in an outer shell of the first section 9, extending in an axial direction. The indicator 13 may be implemented to indicate, for example, a neutral position of the knob 3.

The second section 10 is attached to a second end 14 of the first section 9. The second end 14 is, in the axial direction, oppositely arranged to the first end 11. The second section 10 comprises a flat surface and extends in the axial direction along the rotational axis 6. An aperture is positioned in the center of the second section 10, wherein the central opening 12 is accessible through the aperture. Circumferentially around the aperture, an apron 15 is arranged. The apron 15 protrudes in the axial direction away from the first section 9. The apron 15 is implemented to enhance a sealing effect of the receptacle part 7 with the control panel 2. In particular, the apron 15 may be positioned at the circumference of the aperture of the control panel 2 (not shown in FIG. 2) when the receptacle part 7 and the control panel 2 form a contact surface 16. In particular, the previously mentioned flat surface of the second section 10 may form the contact surface 16.

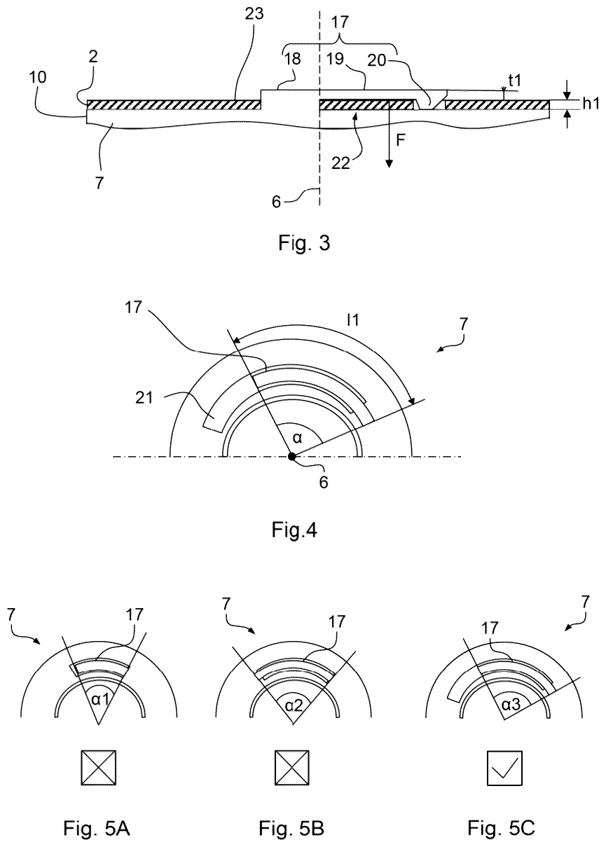

Further, two holding elements 17 protrude from the contact surface 16 in the axial direction away from the first section 9. The holding elements 17 are arranged oppositely around the opening 15, with an angular distance of 180 degrees to each other. The features of the holding elements 17 are described below with reference to one holding element 17, but apply mutatis mutandis to both holding elements 17. For describing the holding element 17, reference is made to FIG. 3 and FIG. 4.

FIG. 3 shows a side view of a cross-section of a section of the control panel 2 (hashed area) and a section of the receptacle part 7, in particular the second section 10, wherein the receptacle part 7 is mounted to the control panel 2. The receptacle part 7 is mounted in a form-fit manner to the control panel 2. In particular, the receptacle part 7 and the control panel 2 are mounted by rotational interlocking, which will be explained later.

FIG. 4 shows a section of a back-side view of an embodiment of the second section 10 of the receptacle part 7. The section shown in FIG. 4 is a semicircular section.

The holding element 17, shown in FIG. 3, comprises a first segment 18, a second segment 19, and a third segment 20. The first segment 18 is coupled to the second section 10 and protrudes from the second section 10 in the axial direction through the control panel 2. The second segment 19 projects perpendicularly from one end of the first segment 18, and is arranged in a circumferential manner, as may be seen in FIG. 4. The second segment 19 has a supported end, connected to the first segment 18, and an unsupported end, positioned opposite to the supported end. The third segment 20 is positioned at the unsupported end and protrudes in the axial direction towards the second section 10 and the control panel 2. The third segment 20 has the shape of a wedge, thus facilitating the initial sliding of the holding element 17 onto the control panel 2. The third segment 20 is secured in an opening of the control panel 2, which will be explained later.

The control panel 2 is clamped by the holding element 17 and the second section 10 of the receptacle part 7. Therefore, the receptacle part 7 is secured in a form-fit manner.

The second section 10 of the receptacle part 7 has a circumferential opening 21 (see FIGS. 3 and 4) extending in the circumferential direction underneath the second segment 19. Through this opening 21, the third segment 20 may be loosened, in case the receptacle part 7 is to be removed from the control panel 2.

The holding element 17 shown in FIG. 3 forms an undercut 22. The undercut 22 extends in the circumferential direction from the first segment 18 to the third segment 20. The undercut 22 may be shaped like a slit and is implemented to receive a coupling section of the control panel 2, which is explained later.

The undercut 22 has a height h1, wherein the height h1 may be equal to or greater than the thickness of the control panel 2. The height h1 may be any value between 0.9 mm and 1.1 mm.

The second segment 19 has a thickness t1 and a circumferential length l1 (see FIG. 4). The ratio of the thickness t1 and the length l1 is, for example, 1:29. Thus, the second segment 19 may have a thickness t1 of 1 mm and a length of 29 mm. The length l1 may sweep a radius with an angle α of 90 degrees. In embodiments not shown in FIG. 4, the angle α may be any value between 70 degrees and 129 degrees. In another example, the radius r1 may be any value between 75 degrees and 95 degrees.

In the coupled state of the receptacle part 7 and the control panel 2, the holding element 17 exercises a holding force F in the axial direction onto a back side 23 of the control panel 2, thus preventing the receptacle part 7 from moving towards the axial direction. The Force F may be an area force, wherein the area force extends between the back side 23 of the control panel 2 and the second segment 19.

The third segment 20 is implemented to prevent the receptacle part 7 from radially moving, which may prevent an unintentional loosening of the receptacle part 7 when mounted.

The dimensions of the holding element 17 are chosen to ensure a coupling to the control panel 2 without the holding element 17 breaking or showing plastic deformations during the coupling process or in the coupled state. FIG. 5A to FIG. 5C show various angles the holding element 17 sweeps over. For these various angles, a simulation was performed, with the receptacle part 7 made from Zamak. Mechanical properties and corresponding values for Zamak are shown in the following table:

Mechanical Properties of Zamak 3

| Properties | Values | |
|---|---|---|
| Ultimate Tensile Strength | 283 | MPa |
| Impact Strength | 58 | J |
| Yield Strength | 221 | MPa |
| Yield Strength | 414 | MPa |
| (Compressive) | | |
| (Fracture) Elongation | 6.3% | |
| (Fmax) Elongation | 3% | |
| Shear Strength | 214 | MPa |
| Fatigue Strength | 48 | MPa |
| Hardness | 82 | Brinell |
| Modulus of Elasticity | 84.3 | GPa |

According to the above table, the yield strength of the material is 221 MPa, depending on which the holding element 17 is designed. A yield point of a material indicates the transition of the material from elastic behavior to plastic behavior and is therefore often used as a design indicator. The yield strength is therefore the maximum allowed stress a material may withstand before having plastic behavior, which is not reversible and thus shall be avoided.

FIG. 5A shows the holding element 17 sweeping over an angle α1 of 49°. The simulation results indicate a maximum stress within the material of 689.11 MPa, which is insufficiently high. FIG. 5B shows the holding element 17 sweeping over an angle α2 of 74°, with the simulation results indicating a maximum stress of 251.45 MPa. FIG. 5C shows the holding element 17 sweeping over an angle of 90°, with the maximum stress in this configuration calculated to be 192.3 MPa. Therefore, the holding element 17 sweeping over an angle of 90° is sufficient.

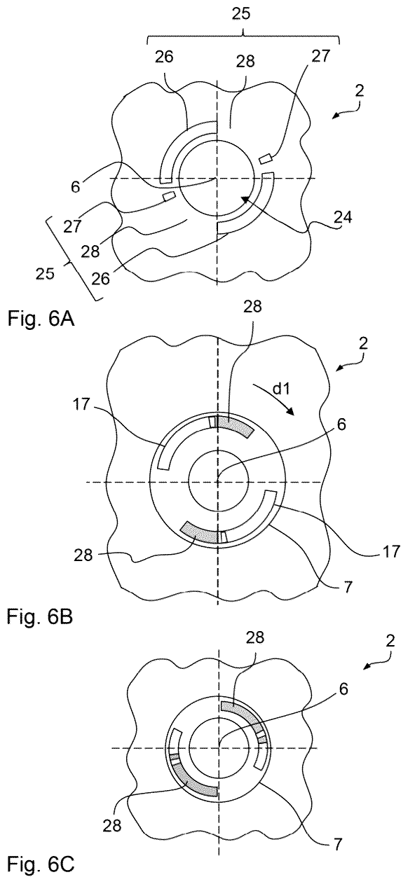

FIGS. 6A-6C show states of mounting the receptacle part 7 to the control panel 2. Thus, a method for mounting the receptacle part 7 to the control panel 2 is illustrated. FIG. 6A shows a front side of a section of an embodiment of the control panel 2. The control panel 2 comprises an aperture 24. The aperture 24 is arranged around the rotational axis 6, wherein the rotational axis 6 goes through a center point of the aperture 24.

Arranged circumferentially around the aperture 24 is a coupling section 25. The coupling section 25 may have an opening 26 and a fixation opening 27. The coupling section 25 is, as shown in FIG. 6A, disconnected from the aperture 24. A holding section 28 is implemented as part of the coupling section 25 and is connected in a one-piece manner to the control panel 2. The holding part 28 protrudes radially towards the rotational axis 6 and separates the opening 26 and the fixation opening 27 in the circumferential direction.

The opening 26 is implemented to receive the holding element 17 of the receptacle part 7, which is shown in FIG. 6B. In a first step, the holding element 17 of the receptacle part 7 is inserted into the opening of the control panel 2. When the holding element 17 is placed in the opening 26, the receptacle part 7 and the front side of the control panel 2 form the contact surface 16, and the central opening 12 of the receptacle part 7 and the aperture 24 form a single through hole, wherein the rotational axis 6 extends through the through hole. Further, in embodiments not shown in FIGS. 6A-6C, control instruments may be arranged, in particular, coupled, through the through hole.

Moving from the state shown in FIG. 6B to the state shown in FIG. 6C, the receptacle part 7 is rotated clockwise, in a locking direction d1 (see FIG. 6B), around the rotational axis 6. Thus, the second segment 19 of the holding element 17 is in FIG. 6C hidden behind the holding section 28.

FIG. 6C shows the mounted state of the receptacle part 7 and the control panel 2, wherein the receptacle part 7 and the control panel 2 are mounted in a form-fit manner by connection of the respective coupling sections 10, 25. In the state shown in FIG. 6C, the third segment 20 is received by the fixation opening 27. When the third segment 20 enters the fixation opening 27, a clicking sound may be heard. When received by the fixation opening 27, the third segment 20 prevents a movement of the receptacle part 7 in the circumferential direction. FIGS. 6A-6C do not have the same scale but the respective elements are reproduced for illustrative reasons.

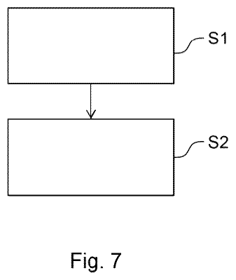

FIG. 7 shows method steps S1 and S2. The method may be exercised for mounting the receptacle part 7 to the control panel 2. The method steps S1 and S2 are shown as an example in FIGS. 6A-6C.

In the step S1, a holding element 17 of the receptacle part 7 is inserted into an opening 26 of the control panel 2, wherein the receptacle part 7 and the control panel 2 form a contact surface 16. The step S1 is shown from FIG. 6A to FIG. 6B. In FIG. 6B the receptacle part 7 is inserted into the opening 26 of the control panel 2.

In the step S2, the receptacle part 7 is rotated around a rotational axis 6 in a locking direction d1. Indicated in FIG. 6B is the locking direction d1. In FIG. 6C, the interlocked state of the control panel 2 and the receptacle part 7 is shown.

Although the present disclosure has been described in accordance with preferred embodiments, it is obvious to the person skilled in the art that modifications are possible in all embodiments.

In another embodiment, the household appliance may be a refrigerator, a washing machine, a dryer, an oven, or a dishwasher. In another embodiment, the knobs are not implemented to rotatable control the household appliance but may be implemented as switches. Thus, the knobs may, if implemented as switches, have a rectangular cross-section. Therefore, also the receptacle part may have a rectangular cross-section. In another embodiment, the control panel and the knobs are arranged on the top side of the household appliance. In embodiments, the third segment of the holding element may at least partly protrude into the circumferential opening underneath the second segment. In other embodiments, the holding element may solely comprise the first segment and the second segment, thus not having a third segment. In other embodiments, the coupling section may be part of the aperture, forming a single opening.

### REFERENCE NUMERALS

1 gas stove
2 control panel
3 knob
4 burner
5 top plate
6 rotational axis
7 receptacle part
8 bottom side
9 first section
10 second section
11 first end
12 central opening
13 indicator
14 second end
15 apron
16 contact surface
17 holding element
18 first segment
19 second segment
20 third segment
21 opening
22 undercut
23 back side
24 aperture
25 coupling section
26 opening
27 fixation opening
28 holding section
α angle
α1 angle
α2 angle
α3 angle
d1 locking direction
F Force
h1 height
l1 length
S1 method step
S2 method step
t1 thickness

In summary, a receptacle part (7) is described for a rotatable knob (3) of a household appliance (1) with a control panel (2), the control panel (2) comprising at least one aperture (24) through which a shaft (40) may be coupled with the rotatable knob (3) along a rotational axis (6). The receptacle part (7) may include: a sleeve portion (9) for partially enclosing the rotatable knob (3); and a coupling portion (10) for removably mounting the receptacle part (7) to the control panel (2), wherein the coupling portion (10) comprises a central opening (12), and at least one holding element (17) implemented to establish a form-fit coupling by rotational interlocking with a corresponding coupling section (25) of the control panel (2).

The enumerated paragraphs below describe aspects and features of the present disclosure.
A0. A receptacle part (7) for a rotatable knob (3) of a household appliance (1) with a control panel (2), the control panel (2) comprising at least one aperture (24) through which a rotational axis (6) extends, wherein a shaft (40) may be coupled with the rotatable knob (3), the receptacle part (7) comprising:
a sleeve portion (9) for partially enclosing the rotatable knob (3); and
a coupling portion (10) for removably mounting the receptacle part (7) to the control panel (2), wherein the coupling portion (10) comprises a central opening (12), and at least one holding element (17) implemented to establish a form-fit coupling by rotational interlocking with a corresponding coupling section (25) of the control panel (2).
A1. The receptacle part (7) according to A0, wherein the holding element (17) comprises:
a first segment (18) protruding in an axial direction from the coupling portion (10); and
a second segment (19) having an unsupported end and extending in a circumferential direction.
A2. The receptacle part (7) according to A1, wherein the second segment (19) further comprises a third segment (20) located at the unsupported end, wherein the third segment (20) extends towards the coupling portion (25) in the axial direction.
A3. The receptacle part (7) according to any one of paragraphs A0 through A2, wherein the holding element (17) is arranged around the central opening (12).
A4. The receptacle part (7) according to any one of paragraphs A0 through A3, wherein the holding element (17) is implemented to exercise an axially directed holding force (F) in a form-fit coupled state.
A5. The receptacle part (7) according to any one of paragraphs A0 through A4, wherein the receptacle part (7) has a cylindrical shape.
A6. The receptacle part (7) according to any one of paragraphs A0 through A5, wherein the receptacle part (7) is at least partially made from a zinc-based alloy.
A7. The receptacle part (7) according to any one of paragraphs A0 through A6, wherein the coupling portion (10) comprises a maximum of two holding elements (17).
B0. A control panel (2) for a household appliance (1), the control panel (2) comprising an aperture (24) through which a rotational axis (6) extends, wherein the aperture (24) comprises at least one coupling section (25) implemented to establish a form-fit coupling by rotational interlocking with a corresponding coupling portion (10), in particular of the receptacle part (7) according to any one of paragraphs A0 through A7, and extending arranged circumferentially around the aperture (24).
B1. The control panel (2) of B0, wherein the at least one coupling section (25) comprises:
at least one opening (26) extending in a radial and circumferential direction, implemented to receive a holding element (17); and
at least one holding section (28) arranged adjacent to the at least one opening (26) and extending circumferentially around the at least one opening (26).
B2. The control panel (2) according to B1, wherein the aperture (24) and the at least one opening (26) are radially separated openings.
B3. The control panel (2) according to any one of paragraphs B0 through B2, wherein the control panel (2) comprises a maximum of two coupling sections (25).
C0. A household appliance (1), comprising:
a receptacle part (7) according to any one of paragraphs A0 through A7; and
a control panel (2) according to any one of paragraphs B0 through B3, wherein the receptacle part (7) and the control panel (2) are coupled to one another in a form-fit manner, and have a contact surface (16) at an outer side of the control panel (2).
C1. The household appliance (1) according to C0, wherein a holding element (7) of the receptacle part (7) exercises a holding force (F) onto a back side of the control panel (2) in a form-fit coupled state.
D0. A method for mounting a receptacle part (7) according to any one of paragraphs A0 through A7 to a control panel (2) according to any one of paragraphs B0 through B3 of a control assembly, the method comprising:
inserting (S1) a holding element (17) of the receptacle part (7) into an opening (26) of the control panel (2), wherein the receptacle part (7) and the control panel (2) form a contact surface (16); and
rotating (S2) the receptacle part (7) around a rotational axis (6) in a locking direction (d1).
E0. A receptacle part for a rotatable knob of a household appliance having a control panel, the control panel comprising at least one aperture through which a rotational axis extends, and through which a shaft can be coupled to the rotatable knob, the receptacle part comprising:
a sleeve portion configured to partially enclose the rotatable knob; and
a coupling portion configured to removably mount the receptacle part to the control panel;
wherein the coupling portion comprises a central opening, and at least one holding element configured to establish a form-fit coupling to the control panel by rotational interlocking with a corresponding coupling section of the control panel.
E1. The receptacle part according to E0, wherein the holding element comprises:
a first segment protruding in an axial direction from the coupling portion; and
a second segment having an unsupported end and extending from the first segment in a circumferential direction.
E2. The receptacle part according to E1, wherein the second segment further comprises a third segment located at the unsupported end, wherein the third segment extends toward the coupling portion in the axial direction.
E3. The receptacle part according to any one of paragraphs E0 through E2, wherein the holding element is arranged around the central opening.
E4. The receptacle part according to any one of paragraphs E0 through E3, wherein the holding element is configured to apply an axially directed holding force when in a form-fit coupled state.
E5. The receptacle part according to any one of paragraphs E0 through E4, wherein the receptacle part has a cylindrical shape.
E6. The receptacle part according to any one of paragraphs E0 through E5, wherein the receptacle part comprises a zinc-based alloy.
E7. The receptacle part according to any one of paragraphs E0 through E6, wherein the coupling portion comprises a maximum of two holding elements.
F0. A control panel for a household appliance, the control panel comprising the aperture through which the rotational axis extends, wherein the aperture comprises a coupling section configured to establish a form-fit coupling by rotational interlocking with a corresponding the coupling portion of the receptacle part according to any one of paragraphs E0 through E7, and extending arranged circumferentially around the aperture.
F1. The control panel of F0, wherein the coupling section of the control panel comprises:
at least one opening extending in a radial and circumferential direction, configured to receive the holding element of the coupling portion of the receptacle part; and
at least one holding section arranged adjacent to the at least one opening and extending circumferentially around the at least one opening.
F2. The control panel according to F1, wherein the aperture and the at least one opening are spaced apart radially.
F3. The control panel according to any one of paragraphs F0 through F2, wherein the control panel comprises a maximum of two of the coupling sections.
G0. A household appliance, comprising:
a receptacle part according to any one of paragraphs E0 through E7; and
a control panel comprising the aperture through which the rotational axis extends, wherein the aperture comprises a coupling section configured to establish a form-fit coupling by rotational interlocking with a corresponding the coupling portion of the receptacle part, and extending arranged circumferentially around the aperture;
wherein the receptacle part and the control panel are coupled to one another in a form-fit manner, and have a contact surface at an outer side of the control panel.
G1. The household appliance according to claim G0, wherein the holding element of the receptacle part applies a holding force onto a back side of the control panel when in a form-fit coupled state.
G2. The household appliance according to G0 or G1, further comprising the features of any one of paragraphs F1 to F3.
H0. A method for mounting the receptacle part according to any one of paragraphs E0 through E7 to a control panel of a control assembly, the control panel comprising the aperture through which the rotational axis extends, wherein the aperture comprises a coupling section configured to establish a form-fit coupling by rotational interlocking with a corresponding the coupling portion of the receptacle part, and extending arranged circumferentially around the aperture, the method comprising:
inserting the holding element of the receptacle part into an opening of the control panel, wherein the receptacle part and the control panel form a contact surface; and
rotating the receptacle part around the rotational axis in a locking direction.
H1. The method of H0, wherein the control panel further comprises the features of any one of paragraphs F1 to F3.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A receptacle part for a rotatable knob of a household appliance having a control panel, the control panel comprising at least one aperture through which a rotational axis extends, and through which a shaft can be coupled to the rotatable knob, the receptacle part comprising:
a sleeve portion configured to partially enclose the rotatable knob; and
a coupling portion configured to removably mount the receptacle part to the control panel;
wherein the coupling portion comprises a central opening, and at least one holding element configured to establish a form-fit coupling to the control panel by rotational interlocking with a corresponding coupling section of the control panel.

2. The receptacle part according to claim 1, wherein the holding element comprises:
a first segment protruding in an axial direction from the coupling portion; and
a second segment having an unsupported end and extending from the first segment in a circumferential direction.

3. The receptacle part according to claim 2, wherein the second segment further comprises a third segment located at the unsupported end, wherein the third segment extends toward the coupling portion in the axial direction.

4. The receptacle part according to claim 1, wherein the holding element is arranged around the central opening.

5. The receptacle part according to claim 1, wherein the holding element is configured to apply an axially directed holding force when in a form-fit coupled state.

6. The receptacle part according to claim 1, wherein the receptacle part has a cylindrical shape.

7. The receptacle part according to claim 1, wherein the receptacle part comprises a zinc-based alloy.

8. The receptacle part according to claim 1, wherein the coupling portion comprises a maximum of two holding elements.

9. A control panel for a household appliance, the control panel comprising the aperture through which the rotational axis extends, wherein the aperture comprises a coupling section configured to establish a form-fit coupling by rotational interlocking with a corresponding the coupling portion of the receptacle part according to claim 1, and extending arranged circumferentially around the aperture.

10. The control panel of claim 9, wherein the coupling section of the control panel comprises:
at least one opening extending in a radial and circumferential direction, configured to receive the holding element of the coupling portion of the receptacle part; and
at least one holding section arranged adjacent to the at least one opening and extending circumferentially around the at least one opening.

11. The control panel according to claim 10, wherein the aperture and the at least one opening are spaced apart radially.

12. The control panel according to claim 9, wherein the control panel comprises a maximum of two of the coupling sections.

13. A household appliance, comprising:
a receptacle part according to claim 1; and
a control panel comprising the aperture through which the rotational axis extends, wherein the aperture comprises a coupling section configured to establish a form-fit coupling by rotational interlocking with a corresponding the coupling portion of the receptacle part, and extending arranged circumferentially around the aperture;
wherein the receptacle part and the control panel are coupled to one another in a form-fit manner, and have a contact surface at an outer side of the control panel.

14. The household appliance according to claim 13, wherein the holding element of the receptacle part applies a holding force onto a back side of the control panel when in a form-fit coupled state.

15. A method for mounting the receptacle part according to claim 1 to a control panel of a control assembly, the control panel comprising the aperture through which the rotational axis extends, wherein the aperture comprises a coupling section configured to establish a form-fit coupling by rotational interlocking with a corresponding the coupling portion of the receptacle part, and extending arranged circumferentially around the aperture, the method comprising:
inserting the holding element of the receptacle part into an opening of the control panel, wherein the receptacle part and the control panel form a contact surface; and
rotating the receptacle part around the rotational axis in a locking direction.
